(19) United States
(12) Patent Application Publication
(10) Pub. No.: US 2004/0193445 A1
(43) Pub. Date: Sep. 30, 2004

(54) Automated informed consent and surgical outcome tracking system and method therefor

(76) Inventors: Carl Lauryssen, Ladue, MO (US); Patricia Ann Gelnar, Syracuse, NY (US)

Correspondence Address: THOMPSON COBURN, LLP, ONE US BANK PLAZA, SUITE 3500, ST LOUIS, MO, 63101, US

(21) Appl. No.: 10/120,019

(22) Filed: Apr. 10, 2002

Related U.S. Application Data
(63) Continuation-in-part of application No. 09/782,128, filed on Feb. 13, 2001.

(51) Int. Cl. G06F 17/60

(52) U.S. Cl. 705/2

(57) ABSTRACT

An improved informed consent and surgical outcome tracking system and method is disclosed. The informed consent portion of the system comprises a visual component, an auditory component, and a textual component. The visual component consists of a visual representation of the surgery, preferably in three-dimensional form. The auditory component consists of a narration integral with the visual component that explains the visual representation of the surgery. The textual component consists of a summary of each complication associated with the surgery. The system includes an input device for inputting an acknowledgment of each complication, and a storage device for storing the patient's acknowledgment of each complication. For the purposes of surgical outcome tracking, the input device further allows a user to input outcome information, the outcome information comprising at least one of the presence or absence of each complication, the presence or absence of a plurality of pre-operative risk factors, and the presence or absence of a plurality of outcome factors associated with each surgery, and surgery information, the surgery information comprising surgeon information, surgery type information, hospital information and geographic information. The outcome and surgery information is stored in the storage device. The system includes a processor configured to aggregate the outcome and surgery information to determine an outcome based thereon. The processor is further adapted to predict the outcome of a surgery for a patient based on a comparison of the presence or absence of pre-operative risk factors for the patient at issue and the outcome information for other patients stored in the storage device.

### CROSS REFERENCE TO RELATED APPLICATIONS

This application is a continuation-in-part of patent application Ser. No. 09/782,128 entitled “Informed Consent System and Method Therefor,” filed Feb. 13, 2001.

A model of the invention in the form of a compact disc is attached hereto as Appendix A, and incorporated herein by reference.

### BACKGROUND OF THE INVENTION

The present invention relates to an automated system and method of obtaining informed consent from patients undergoing surgeries, and for tracking the outcomes thereof.

According to the American Medical Association (AMA), in 1998 there were 140,236 surgeons, anesthesiologists and cardiologists in the U.S. performing 71.9 million invasive medical procedures per year in the U.S. alone. The number of procedures performed was projected to increase at least 5%-10% every 5 years for the next 25 years. Before a patient undergoes surgery, his or her informed consent must be obtained. The primary method of surgical informed consent is a verbal consent process, which consists of the surgeon explaining verbally to a patient and/or his or her family how a procedure is performed and the risks associated with surgery. The quality and consistency of verbal informed consents vary significantly between surgeons because of variations in communication skills, time available, and a surgeon's ability and willingness to outline all of the possible complications. This is particularly a problem in teaching hospitals (367 such hospitals in the United States alone), as informed consent is usually obtained by inexperienced doctors in training (interns) or resident physicians who often have a poor understanding of the surgery and potential complications, and typically are functioning on very little sleep. These variables result in disparities in the surgical informed consent. Because of this considerable variability, it is quite common for patients to feel that they are not adequately informed about the procedure and all of the risks involved.

One of the most common reasons for medical malpractice suits after surgery is a patient's contention that the physician did not fully explain the risks and potential complications associated with surgery. Given the inadequacies of the current informed consent procedures, any unforeseen or unsatisfactory outcome can easily lead to litigation. These problems are exacerbated in the area of complex, high-risk medical procedures, such as neurosurgery, spine surgery, cardiothoracic surgery, vascular surgery, and obstetrics.

Further, medical malpractice cases typically are more likely to go to trial than any other type of civil case, last longer, and consistently result in high monetary awards to plaintiffs. Given the number of medical procedures performed each year, and the projected increase in such numbers, the loss in time and costs for defending such cases is an enormous burden on physicians, hospitals, and ultimately patients. An additional challenge for surgeons in the near future is an increased need for surgery in our aging population. Therefore, in order to meet this increasing need, surgeons need to become more effective and efficient in the manner in which they handle informed consent.

Several informed consent systems have been developed to try to overcome some of these problems. Some systems employ written materials to help educate patients. Such systems, however, require the physicians to be present during review of the material, and ultimately still rely mainly on a subsequent verbal explanation of the surgery. Other systems employ videotapes. Such tapes, however, use simple animations, which cannot convey accurate surgical relationships and information. In addition, no detailed information on risk frequency and consequences is provided. Moreover, the systems can only be used in sites where a TV/VCR is available. Finally, all such systems do not allow for easy and accurate reproduction of the entire informed consent process.

With any surgical procedure, however, there are always risks of complications. And, with the risk of complications, there is always the risk of liability, regardless of the quality of the informed consent. Medical malpractice insurance premiums (and health insurance premiums generally) should ideally be based in part on outcome information such as the type and number of complications encountered by a surgeon and/or hospital in connection with the surgeries being performed, as well as other factors relevant to a patient's outcome, such as a patient's length of hospital stay, type of discharge (i.e. home without assistance, home with physical therapy, home with rehab, outpatient rehab or nursing home) and disposition status (i.e. ambulatory without assistance, ambulatory with cane, ambulatory with walker, wheelchair bound or bed bound) to name a few. However, there is currently no system for reliably and automatically tracking such outcome information. Since outcome information is not tracked, it is also impossible for surgeons and/or hospitals to identify problems, let alone try to take steps to fix them. Moreover, given the lack of outcome information tracking, there is currently no benchmark from which to gauge how a particular surgeon or hospital is doing.

Currently, the only way to track outcomes and thus aggregate such information is manually on a retrospective basis. The more manual and retrospective the process, however, the more time consuming and costly the process, and the greater risk for human error or inaccuracies in the collected information. Such a manual process also prevents the automatic and reliable tracking of surgical outcomes on a variety of different bases, such as on a surgeon-by-surgeon basis, a hospital-by-hospital basis, a surgical volume basis (for example, the total number of surgical procedures per surgeon and/or per hospital), a geographical basis (for example, local, regional, national, international), an outcome factors basis or any combination thereof.

Moreover, to the extent outcomes are manually determined today, they are based only on post-operative information. However, outcomes may also be affected by a patient's pre-operative risk factors, which can be a patient's age, weight, medical history, whether he or she smokes, etc. Given the potential impact of pre-operative risk factors on the outcome of a surgery, the ability to identify them can help to more effectively manage and reduce medical complications and malpractice liability. Given the time, resources and costs associated with such complications and liability, a system and method providing such capabilities is of critical importance to any surgeon and/or hospital.

Accordingly there is a need for an improved system and method of obtaining informed consent from patients undergoing surgeries and tracking the outcomes thereof that overcome these problems.

### SUMMARY OF THE INVENTION

A system for obtaining informed consent from patients undergoing surgeries and tracking the outcomes thereof is disclosed. One embodiment of the system comprises a visual representation of the surgery, an auditory component integral with the visual representation, the audio component comprising a narration explaining the visual representation of the surgery, a textual component integral with the visual representation and the auditory component, the textual component comprising a summary of each complication associated with the surgery, and an input mechanism for inputting an acknowledgment of each complication. In one embodiment, the visual representation is three-dimensional. The textual component may further comprise a mechanism for identifying a complication about which the patient desires further information. The system further comprises a storage device for electronically storing the patient's acknowledgment of each complication.

The input device may be further configured to permit a user of the system to input outcome information for each patient, the outcome information comprising at least one of the presence or absence of each complication associated with each patient's surgery, the presence or absence of a plurality of pre-operative risk factors associated with each patient's surgery, and the presence or absence of a plurality of outcome factors associated with each patient's surgery, the storage device may be further configured to store the outcome information for each patient, and the system may further comprise a processor configured to aggregate the outcome information and to determine an outcome based on the aggregated outcome information. In one embodiment, the outcome determined by the processor is based on at least one of the pre-operative risk factors, the complications, and the outcome factors.

The input device may be further configured to permit a user of the system to input for each patient surgery information comprising at least one of surgeon information, surgery type information, hospital information and geographic information, and the processor may be further configured to aggregate the surgery information and to determine an outcome based on the aggregated surgery information. In one embodiment, the outcome is based on an at least one of the surgeon information, the surgery type information, the hospital information and the geographic information. The processor may be further configured to determine a surgical volume for at least one of the surgeon information, the surgery type information, the hospital information and the geographic information and determine an outcome based on at least one of the surgeon surgical volume, the surgery type surgical volume, the hospital surgical volume, and the geographic surgical volume.

The processor may be further configured to predict an outcome of a surgery for a patient based on a comparison of the presence or absence of pre-operative risk factors for the patient and the outcome information of other patients stored in the storage device.

An automated system for obtaining informed consent from a patient undergoing surgery comprising a display configured to display a plurality of complications associated with the surgery, an input device in communication with the display configured to permit a user of the system to input a patient's acknowledgment of each complication, the input device further being configured to permit a user to input outcome information for each patient, the outcome information comprising at least one of the presence or absence of a plurality of pre-operative risk factors associated with each surgery, the presence or absence of each complication associated with the surgery, and the presence or absence of a plurality of outcomes associated with the surgery, a storage device configured to store the outcome information for each patient, and a processor configured to aggregate the outcome information and determine an outcome based on the aggregated outcome information is also disclosed. In one embodiment, the outcome is based on at least one of the pre-operative risk factors, the complications, and the outcome factors.

The input device may be further configured to permit a user of the system to input surgery information comprising at least one of surgeon information, surgery type information, hospital information and geographic information, and the processor may be further configured to aggregate the surgery information and determine an outcome based on the aggregated surgery information. In one embodiment, the outcome is based on at least one of the surgeon information, the surgery type information, the hospital information and the geographic information. The processor may be further configured to determine a surgical volume for at least one of the surgeon information, the surgery type information, the hospital information and the geographic information and to determine an outcome based on at least one of the surgeon surgical volume, the surgery type surgical volume, the hospital surgical volume, and the geographic surgical volume.

The processor is further configured to predict an outcome of a surgery for a patient based on a comparison of the presence or absence of the pre-operative risk factors for the patient and the outcome information of other patients stored in the storage device.

A method of obtaining informed consent from a patient undergoing a surgery is also disclosed. The method comprises displaying the surgery visually to the patient, providing narration to accompany the visually displayed surgery, displaying a summary of each complication associated with the surgery, and requesting acknowledgment from the patient of each complication, wherein the visual representation, the narration, the summary, and the acknowledgment request are integrally combined in a single informed consent system. In one embodiment the surgery is visually displayed in a three-dimensional form. The method may further comprise the step of requesting identification of each complication about which the patient desires further information. The method further comprises the step of electronically storing the patient's acknowledgment of each complication.

An automated method for determining outcomes of surgeries undergone by patients comprising displaying for each surgery a plurality of complications associated with each surgery and at least one of a plurality of pre-operative risk factors and a plurality of outcome factors associated therewith, storing for each surgery a patient's acknowledgment of each complication and outcome information associated with the surgery, the outcome information comprising at least one of the presence or absence of each complication, the presence or absence of each pre-operative risk factor, and the presence or absence of each outcome factor, aggregating the outcome information, and determining an outcome based on the aggregated outcome information is also disclosed. In one embodiment, the outcome is based on at least one of the pre-operative risk factors, the complications and the outcome factors is also disclosed.

The method may further comprise storing at least one of surgeon information, surgery type information, hospital information and geographic information, aggregating the surgeon information, and determining an outcome based on the aggregated surgery information. In one embodiment the outcome is based on at least one of the surgeon information, the surgery type information, the hospital information, and the geographic information. The method may further comprise determining a surgical volume for at least one of the surgeon information, the surgery type information, the hospital information and the geographic information, and determining an outcome based on the surgeon surgical volume, the surgery type surgical volume, the hospital surgical volume and the geographic surgical volume.

The method may further comprise comparing the pre-operative risk factors for a patient undergoing a surgery to the outcome information for other patients, and predicting an outcome of the surgery based on the comparison.

While the principal advantages and features of the present invention have been explained above, a more complete understanding of the invention may be attained by referring to the drawings and description of the invention below.

### BRIEF DESCRIPTION OF THE FIGURES

FIG. 1 displays a schematic of one embodiment of the informed consent portion of the informed consent and surgical outcome tracking system of the present invention;

FIGS. 2A and 2B display exemplary graphic components of the informed consent portion of FIG. 1;

FIG. 3 displays a flowchart of one embodiment of the informed consent portion of FIG. 1 in operation;

FIG. 4 displays a schematic of one embodiment of the surgical outcome tracking portion of the present invention;

FIG. 5 displays an example of one complication displayed to a user of the informed consent system of FIG. 1;

FIG. 6 displays a flowchart of one embodiment of the surgical outcome tracking portion of FIG. 4 in operation; and

FIG. 7 is an example of a screen display for inputting outcome information as set forth in FIG. 6.

### DETAILED DESCRIPTION OF THE INVENTION

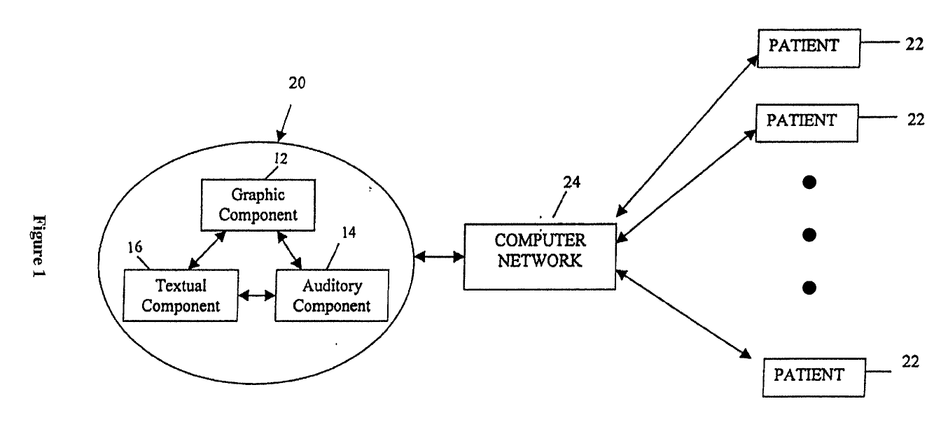

The present invention relates to an automated system and method of obtaining informed consent from patients undergoing surgeries and tracking the outcomes thereof. The informed consent portion of the system will first be described, followed by a description of the outcome tracking portion of the system. Referring to FIG. 1, an informed consent system 20, preferably in the form of software, is accessible to a plurality of patients 22 through a computer network 24, such as the Internet. In one embodiment, the system 20 is made available to doctors and hospitals on a subscription basis through a web-based medium 24 hours per day, 7 days per week. A web-based system is ideal because it allows the surgeon access at all patient care sites. Surgeon offices are equipped with computers and Internet access, hospitals have computers with Internet access in every patient care area, and some hospitals even supply computers for use in patient rooms. Wireless Internet computers and hand held devices, also enhance patient accessibility. In addition, by automating the process, all of the information entered into the system 20 can be stored on a centralized and secure database (not shown) for future use. It can be appreciated, however, that the system 20 can be a stand-alone system installed separately at each participating patient care site or can be implemented in a network configuration. In addition, while the system will be discussed with respect to a neurosurgical operation, namely an anterior cervical diskectomy, it can be appreciated that it can be used for any type of surgical operation.

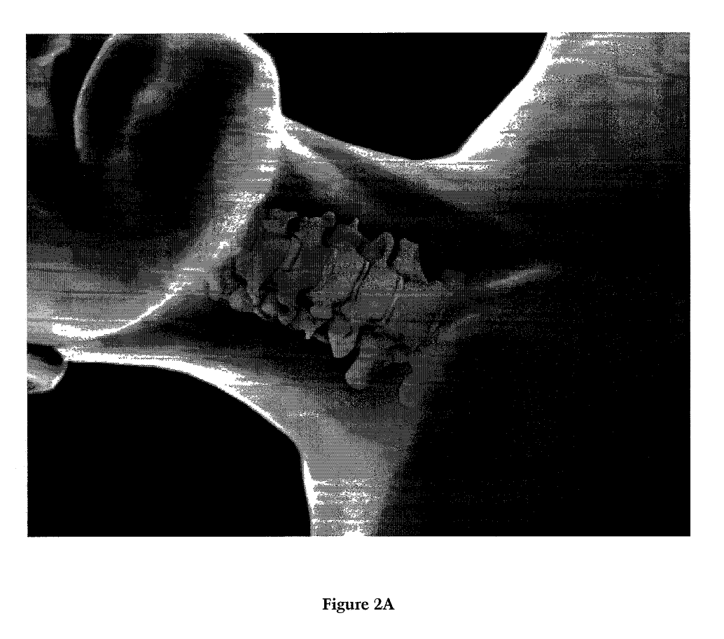

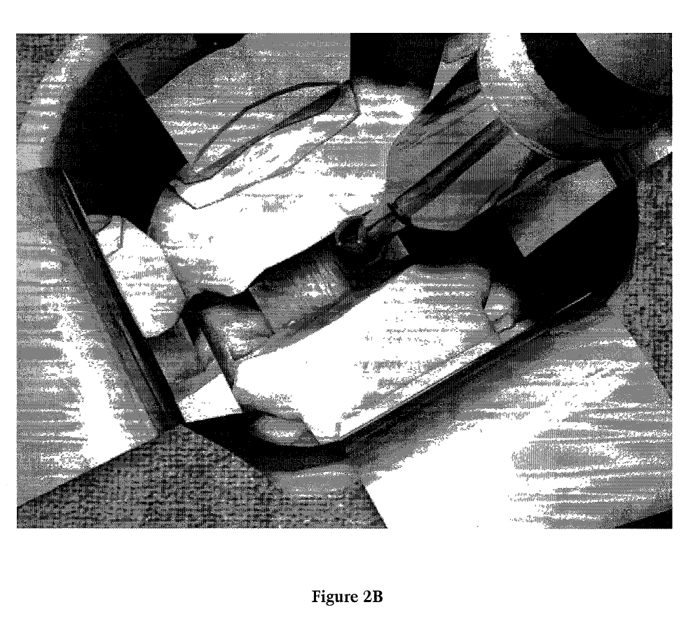

The informed consent system 20 includes a visual or graphic component 12, an auditory component 14, and a textual component 16 integral with the graphic component 12 and the auditory component 14. The visual component 12 consists of a detailed 3-dimensional (3D) animation of the surgery. Such animation permits all angles of the surgical anatomy and nearby important structures that could be damaged during surgery to be easily conveyed to the patient. The visual component 12 is preferably developed with input from experienced and respected surgeons in the pertinent field. In particular, the visual component 12 details each step of the surgery, from the start of the operation to its completion. One example of an animation is shown in a compact disc (CD) attached hereto as Appendix A and incorporated herein by reference. As shown, the animation demonstrates the tissues that are cut, removed, and/or repaired during surgery and their relation to other nearby important structures. Examples of two frames of such an animation are displayed in FIGS. 2A and 2B.

The auditory component 14 consists of narration accompanying the visual component 12 that explains the surgical anatomy, methods, and possible complications associated with each step of the procedure. The narrative script for this auditory component is displayed below. The “/////” within the script denotes the end of a step or stage of the surgery.

### EXAMPLE

### Narrative Script for Anterior Cervical Diskectomy and Fusion with Plating

1. Welcome to the Graphic Surgery Consent for an Anterior Cervical Diskectomy and Fusion with Plating.

2. Not every surgeon performs this operation exactly the same way, and every complication associated with this procedure cannot be predicted. However, the important steps used in almost all anterior cervical diskectomies, and most of the potential complications or problems associated with this surgery will be explained.

3. Your surgery is performed while under general anesthesia. Only after safely starting general anesthesia will the spine surgeon begin your surgery. If you wish more information about general anesthesia you should talk to your anesthesiologist. You can also ask if they offer the Graphic Surgery Consent for general anesthesia to their patients. //////////

4. Your surgeon will probably use special magnifying glasses or a microscope during at least part of this operation.

5. The first step in an anterior cervical diskectomy is for the surgeon to locate the area on your neck over the disk that is to be removed. The skin is cleaned with a combination of liquids such as hibicleanse, betadine, alcohol, iodine or another soap before starting the surgery. If you are allergic to any of these materials, you should tell your surgeon before surgery. The anesthesiologist will also give you an antibiotic through your IV before surgery starts, so you should be sure to inform both your surgeon and anesthesiologist of all your medication allergies. ///////////////

6. An incision about 1½ to 2 inches long is then made in or near one of the skin folds. If more than two disks are to be removed, a longer incision is used and may be in a different direction. Numbness in the area of the incision after surgery is not unusual.

7. After the skin has been opened, the muscle just below the skin called the platysma is divided. ///////////////

8. The surgeon then carefully develops a pathway between the muscles in the neck all the way down to the spine. This pathway can be developed using either surgical instruments or the surgeon's finger.

9. The pathway between the neck muscles is developed so that the esophagus, trachea, and nerve to the vocal cords are moved medially and the carotid artery and jugular vein are moved laterally. Before proceeding any further the surgeon usually checks to make certain that these structures are properly positioned.

10. Because the carotid artery, esophagus, trachea (commonly called the windpipe), and nerve controlling the vocal cords are so close to the area being operated on, there is a very small risk (usually less than 0.5% or 5 out of 1,000 people) that any or all of these structures could be damaged during the surgery.

11. If any of these structures are damaged, the surgery for removal of the disk may be stopped. Additional surgery is usually needed to repair damage to these structures, and another surgeon may be needed.

12. Hoarsenesss after this operation is very common and occurs in up to 15% of patients. The hoarseness is usually caused by swelling, is temporary, and improves over over several days. However, in 4% or less of patients the nerve controlling the vocal cords can be damaged, and the hoarseness may be permanent.

13. Special instruments called retractors are carefully placed in the wound to hold open this pathway, and keep the muscles, carotid artery, esophagus, and trachea out of the surgeon's way. //////////////

14. Now the spine and disks can be seen. A needle is usually inserted into one of the disks, and an X-ray is taken to confirm the correct disk level. In patients who have thick necks from muscle or fat, the disks may be very difficult to see on X-ray, and in this situation there is a small risk of operating on the wrong disk.

15. When the surgeon is sure of the disk to be operated on, threaded pins are inserted into the bones above and below the disk and a special instrument is used to help open up the disk space. ///////////////

16. The disk is cut open and removed using a variety of grasping instruments and drills.

17. A ligament just behind the disk can also be opened after the disk has been removed to check for any additional pieces of herniated disk.

18. If there are enlarged pieces of bone (called bone spurs) pushing on either the spinal cord or the nerves, they are carefully removed with special instruments.

19. During removal of the disk and bone spurs there is a small risk that the spinal cord, nerves, or the covering around the spinal cord can be damaged.

20. Damage to the spinal cord or nerves during surgery is rare but can result in numbness, tingling, muscle weakness or even paralysis. Damage to the spinal cord occurs in 3% or less of patients and occurs most often in those patients who have signs of a spinal cord problem before surgery (usually called a myelopathy). Damage to individual nerves is even more rare and happens in only about 0.3% of patients.

21. In about 2% or less of patients the covering around the spinal cord and nerves is torn, allowing fluid to leak out. The tear can usually be directly repaired and causes no further problems. ///////////////

22. After the disk and bone spurs have been removed, the cartilage is scraped off the edges of the bones above and below the disk, so that the bones can grow together.

23. There is a risk that too much bone can be removed during surgery, and if this happens a fusion and plating may be needed even if not originally planned. ///////////////

24. If a fusion is performed, bone (either from a bone bank or from your hip) is carefully measured, shaped, and inserted into the empty disk space. There is a very small risk that the bone can be placed in too far and put pressure on the spinal cord.

25. After surgery, in up to 13% of cases the inserted bone comes out of the disk space. If the bone does come out it usually does not cause any problems, but in very rare cases it can put pressure on nearby important structures such as the esophagus or trachea.

26. The pins used to help separate the bones are removed. ///////////////

27. A strong metal plate (usually titanium) is placed over the bone graft, and screws are placed into the bones above and below to secure the plate. This metal plate acts as an internal neck brace, improves bone healing (called fusion), and basically removes the risk of the bone coming out after surgery.

28. In anywhere from 8%-20% of patients undergoing plating the screws or plate can come loose or break. In most of these cases the loose or broken instrument does not cause any serious problems, but a surgery is usually performed to remove the or loose implant. It is extremely rare, but has been reported that a loose or broken implant can press on a nearby structure (such as the esophagus or trachea) and cause problems with swallowing or breathing.

29. There is an even smaller risk that one of the screws can damage a nerve, the spinal cord or a nearby disk (no #'s). ///////////////

30. At this point the surgery is almost finished. The surgeon stops any visible bleeding, and then washes out the wound with an antibiotic solution.

31. The wound is closed by placing sutures or stitches (which will dissolve) in the platysma muscle and the skin. Glue or small strips of tape are usually placed over the incision, and a bandage is placed over the area.

32. There is a risk of bleeding after surgery. If a large blood clot forms it can cause pressure on the spinal cord (0.9%) or problems with breathing or swallowing (1.5%). These large blood clots only occur in 1.5% or less of patients, but if it does occur emergency surgery may be required to remove the blood clot.

33. After surgery anywhere from 0.3%-3% of all patients suffer from an infection at the surgical site and may require treatment with antibiotics, wound care, or even additional surgery. The risk of infection is usually highest in patients undergoing repeat surgery and those with diabetes.

34. Occasionally the incision does not heal properly after surgery. Most cases of poor wound healing are caused by infections and/or severe diabetes. ///////////////

35. If a fusion has been performed a neck brace may be placed around your neck in the operating room to help the bone heal. In about 5% of patients who undergo a single level fusion (and about 15% of those who have fusions across more than one disk level) the bones do not heal properly. Most patients with poor bone healing have no problems, but if a patient does develop problems, another surgery is usually necessary.

36. The anesthesiologist then allows the patient to wake up and removes the breathing tube.

37. After you are awake and breathing well, you will be taken to the recovery room where you will stay until more fully awake.

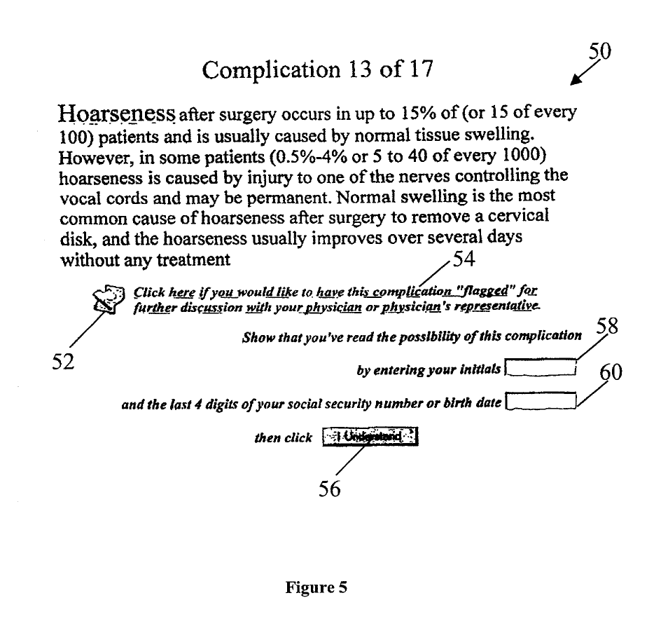

The textual component 16 consists of a textual report of the potential surgical complications, and further explains and reinforces the understanding of potential complications associated with the surgical procedure. Details relating to and explaining potential complications are based upon an exhaustive review of the scientific literature. The textual component 16 identifies each potential complication and requires the patient to acknowledge each complication in writing, preferably electronically. An example of a complication 50 displayed via the informed consent system 20 is shown in FIG. 5. Complication 50 includes a brief explanation of each complication and the frequency with which it occurs. If a patient desires further information about the complication, that complication can be flagged or identified for further review with the surgeon by clicking on the flag 52 or the hyperlink 54. The patient must acknowledge the complication by clicking on the acknowledge button 56. In one embodiment, the patient must also input some personal information, such as his or her initials via input box 58 and the last four digits of his or her social security number or birth date via input box 60. The patient's acknowledgment is stored in a memory (not shown) of the informed consent system 20.

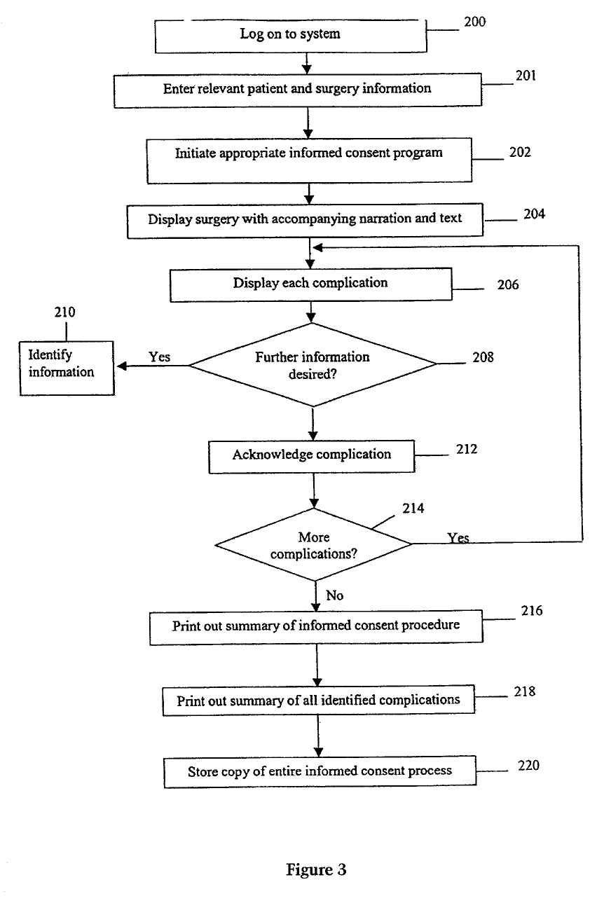

The informed consent system 20 will now be described in operation with reference to FIG. 3. At 200, a medical staff person (i.e., secretary, nurse, doctor) enters a password to log on to the informed consent system 20. It can be appreciated that the medical staff person need not be physically present in the hospital, the physician's office or a medical facility in order to operate the system. In a preferred embodiment, the password is associated with a particular surgeon. At 201, the medical staff person enters relevant information about the patient (i.e., name, address, age, etc.), surgeon (if not tied with password) and the type of surgery. In the case where the system 20 is also used to track the outcomes of surgical procedures, a patient's pre-operative risk factors (which shall be later referred to and defined herein as outcome information) may also be entered at 201. Such risk factors may include without limitation a patient's age, weight, and medical history, as well as whether or not he or she smokes. At 202, the patient initiates the appropriate informed consent program for his or her surgery. At 204, the surgery is visually displayed to the patient, along with the accompanying auditory and textual components. At 206, each of the potential complications associated with the surgery is then displayed in a textual format. At 208, a check is made whether the patient wishes to further discuss the complication. If so, at 210, the patient can identify the complication. At 212, the patient acknowledges the complication, which is stored by the informed consent system 20, preferably in a database form. In an alternative embodiment, all of the complications can be presented to the patient at one time. At 216, a summary of the informed consent is printed, and at 218, a summary of any identified complications is printed, all for inclusion in the physician and/or hospital record.

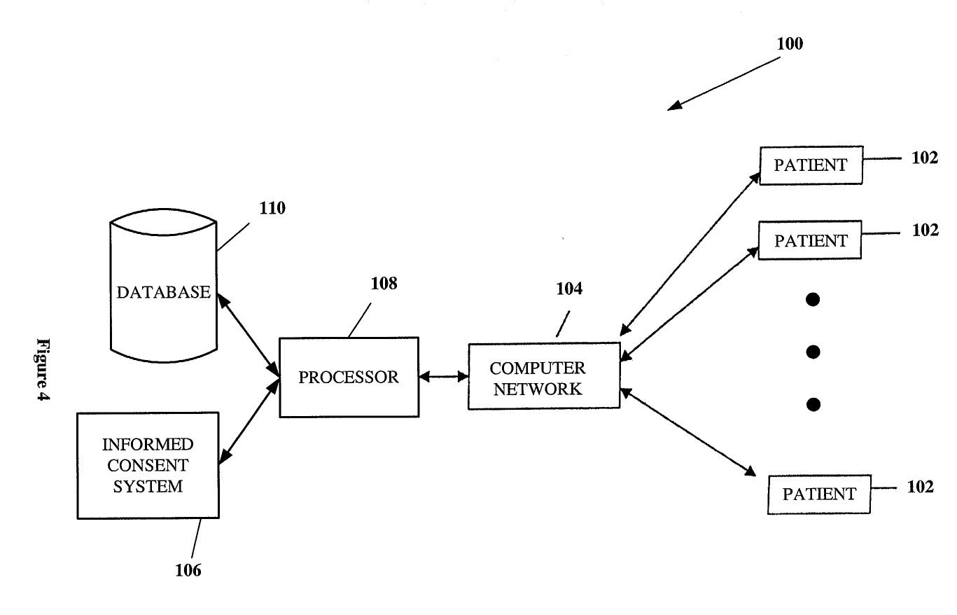

In the case where the system 20 is also being used to track the outcome of surgical procedures, a user of the system 20 can query a database of outcome information as shown in FIG. 4 (the creation of which is further described herein) in order to predict the outcome of the surgery for the patient based on a comparison between the patient's pre-operative risk factors and the outcome information for other patients stored in said database. At 220, a copy of the entire informed consent process is stored by the informed consent system 20, preferably in a centralized and secure database such as database 110 of FIG. 4. In a preferred embodiment, the informed consent system 20 allows the patient to replay the entire procedure or segments thereof at any time.

Due to the nature of the informed consent system 20, it can be studied by the patient in the absence of a surgeon for an unlimited period of time until a satisfactory understanding of the material is achieved. As a result, the surgeon is allowed to perform other tasks and thus increase his or her efficiency. Furthermore, after the patient has completed review of the informed consent system 20, he or she is better equipped to discuss the surgery with the surgeon, thereby further reducing the amount of the surgeon's time required. Finally, since each of the components of the informed consent system 20 are integrally combined in a single mechanism, it can be easily and accurately reproduced for a deposition or in a court of law, thereby reducing the surgeon's or hospital's liability.

In a preferred embodiment, the informed consent system 20 is provided to surgeons and hospitals based on subscription rates. In the case of surgeons, the rates are based in turn upon the number of surgeons in a specialty and the malpractice rates for that specialty. In the case of hospitals, subscription rates are based in turn upon the number of specialty-related hospital beds. Based upon average neurosurgery practice values and the conservative assumption that the informed consent system 20 saves the surgeon ten (10) minutes for each informed consent, increased productivity can result in thousands of dollars savings per year per neurosurgeon, and a potential decrease in malpractice premiums.

As previously discussed herein, the system of the present invention may also be used to help track the outcomes of patients undergoing surgery. The outcome may be based on the presence or absence of complications associated with the surgery, as well as other factors that can impact the outcome. The outcome may also be affected by the presence or absence of a plurality of pre-operative risk factors associated with the surgery as previously described herein. In other words, the outcome can be based on both pre-operative and post-operative information. The absence or presence of complications and pre-operative risk factors, as well as the outcome factors will be collectively referred to and defined herein as outcome information. In the case of hospitals, the outcome factors may include without limitation the length of hospital stay, blood transfusion and if so transfusion reaction, skin breakdown, medication error, patient falls, use of patient restraints, type of patient discharge (i.e., home without assistance, home with physical therapy, home with rehab, outpatient rehab, or nursing home), patient disposition status (i.e., ambulatory without assistance, ambulatory with cane, ambulatory with walker, wheelchair bound, or bed bound), and/or readmission to hospital within 30 days. In the case of physicians, the outcome factors may include the length of hospital stay, blood transfusion, time away from work, type of patient discharge (i.e., home without assistance, home with physical therapy, home with rehab, outpatient rehab, or nursing home), patient disposition status (i.e., ambulatory without assistance, ambulatory with cane, ambulatory with walker, wheelchair bound, or bed bound), and/or readmission to hospital within 30 days. For example, in the case of an anterior cervical diskectomy, a patient that has a desk job is more likely to return to work earlier than a patient whose job involves physical labor. As previously discussed herein, pre-operative risk factors may include without limitation a patient's weight, age and medical history, as well as whether or not he or she smokes. The pre-operative risk factors may of course change depending on the surgery involved.

One embodiment of the surgical tracking outcome portion 100 of the present invention is shown in FIG. 4. In particular, a plurality of users 102 may send a surgical outcome tracking request through a computer network 104 such as the Internet, to a processor 108 configured to process such requests. It can be appreciated, however, that the surgical tracking outcome portion 100 of the present invention can likewise be implemented in a stand-alone or network configuration. The processor 108 interfaces an informed consent system 106 for obtaining a patient's informed consent before the surgery. The informed consent system 106 can be of the type shown in FIG. 1 and described herein, or may be any informed consent system that allows the patient to input and stores a patient's acknowledgment of a plurality of complications associated with a surgery being undergone by the patient, and preferably allows the user of the system to input the presence or absence of a plurality of pre-operative risk factors associated with the surgery.

The processor 108 also interfaces a storage device such as a database 110 for storing the outcome information. The database 110 also interfaces the informed consent system 106 to store outcome information in the form of a patient's pre-operative risk factors, as well as any other relevant information input as a result of the informed consent process. The processor 108 is configured to aggregate the outcome information stored in the database 110 so that an outcome can be determined. The outcome can be broken down on a plurality of different bases, as discussed further below. The processor 108 is also configured to compare the presence or absence of a plurality of pre-operative risk factors for a particular patient to the outcome information of other patients stored in the database 110 to help predict an outcome. It can be appreciated that more than one processor, database and informed consent system may be used for redundancy and/or load balancing purposes.

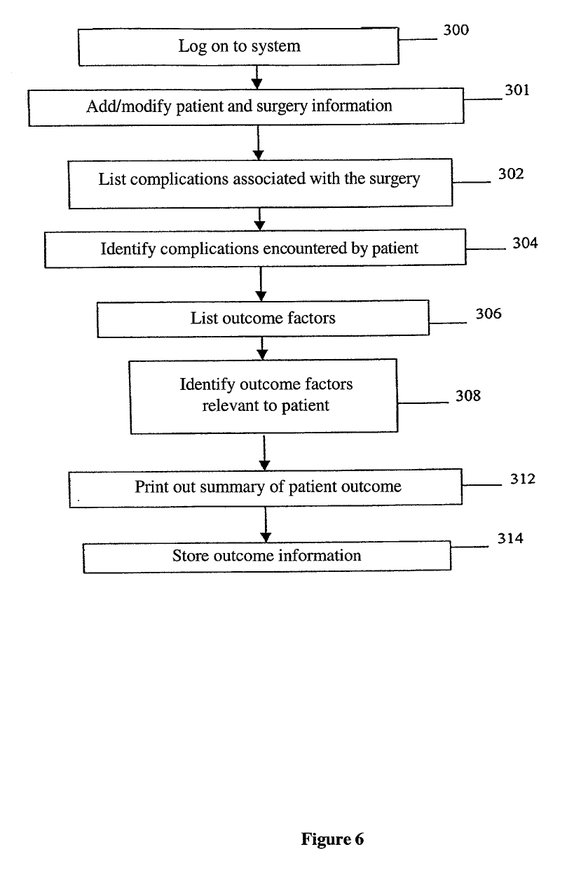

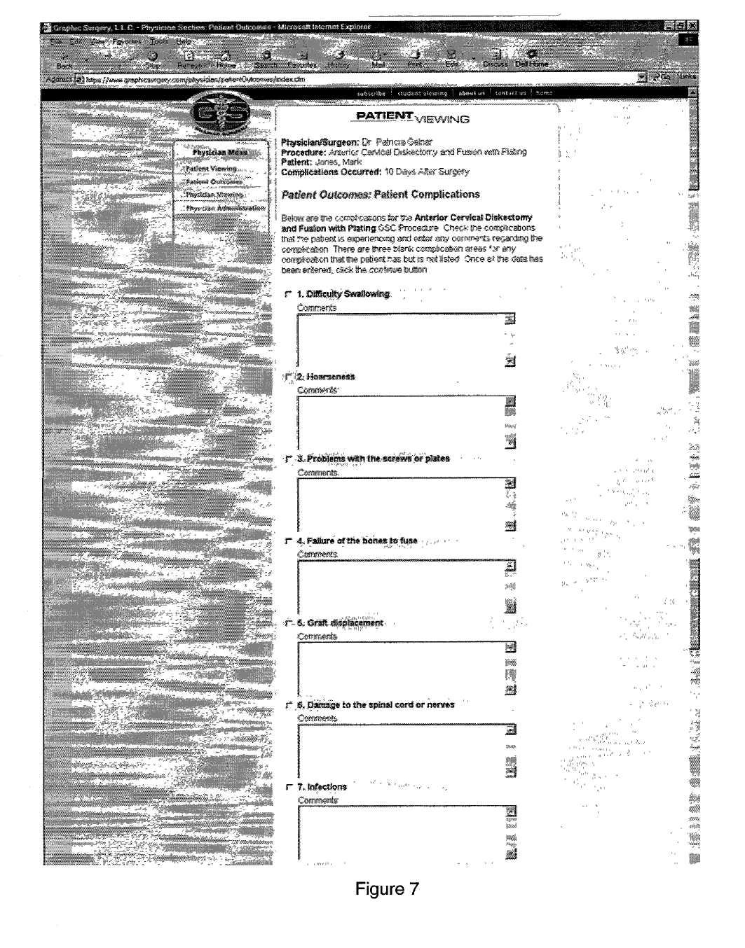

The operation of the surgical outcome tracking feature of the present invention will now be discussed with respect to FIG. 6. At 300, a physician (or his or her designated representative) or a hospital representative (hereinafter “the user”) enters a password to log on to the informed consent mechanism 20. As previously stated, the user need not be physically present in the hospital, the physician's office or a medical facility to operate the system. At 301, the user may either add or modify the current information in the system for the patient, surgeon, and/or the surgery at issue. At 302, a list of the complications associated with the surgery at issue is displayed. An example of one such list for an anterior cervical diskectomy surgery is shown in FIG. 7. It can be appreciated that the list is just for illustrative purposes only and would be different for different surgeries. At 304, the user identifies the complications encountered by the patient. It can be appreciated that each complication could be separately displayed to the user such that he or she identifies such complications as each is displayed. At 306, a list of the outcome factors associated with the surgery at issue is displayed. At 308, the user identifies those outcome factors applicable to the patient at issue. At 310, a summary of the patient's outcome is printed out. The summary includes a list of all complications and outcome factors associated with the surgery at issue so that both the presence and absence thereof may be noted. It can be appreciated, however, that only the identified complications and outcome factors may be included depending on the user's needs. At 312, the outcome information is stored by the system in an outcome database 110 as shown in FIG. 4 again. It should be appreciated that both the absence and presence of complications, outcome factors, and/or pre-operative risk factors are preferably stored in the outcome database 110 since they may both have an impact on any complication rates calculated by the system.

By accumulating and storing such outcome information, complication rates and outcomes can be broken down on a plurality of different bases. In particular, since the outcome information for each patient is tied to a particular surgeon and hospital, the outcome or rates can be broken down by surgeon and/or hospital, and further by geographical area on as small or large a scale as desired. For example, a national average per surgical procedure, surgeon and/or hospital can be calculated. Such information is particularly useful for insurance companies setting premiums. For example, if a surgeon is well above or below the standard complication rate for a particular surgery, his or her premium can be adjusted accordingly. The present invention also allows the tracking of outcomes by volume. For instance, one can determine whether a hospital or surgeon that conducts more of a particular surgical procedure has a better complication rate than a hospital or surgeon that does not. Outcomes can also be broken down by any of the outcome information stored in database 110. In the case of pre-operative risk factors, an outcome can be predicted. For example, in the case of the cervical diskectomy procedure described herein, it may be shown that diabetic patients over the age of 60 are more likely to encounter a complication of a deep wound infection than non-diabetic patients or diabetic patients under the age of 60. Not only can this improve the informed consent process, it in turn helps further reduce the risk of liability associated with it by allowing the informed consent to be customized or individualized at the patient level.

The foregoing constitutes a description of various features of a preferred embodiment. Numerous changes to the preferred embodiment are possible without departing from the spirit and scope of the invention. Hence, the scope of the invention should be determined with reference not to the preferred embodiment, but to the following claims.

We claim:

1. An automated system for obtaining informed consent from a patient undergoing a surgery, comprising:
a visual representation of the surgery;
an auditory component integral with the visual representation, the audio component comprising a narration explaining the visual representation of the surgery;
a textual component integral with the visual representation and the auditory component, the textual component comprising a summary of each complication associated with the surgery;
an input device configured to permit a patient to input an acknowledgment of each complication; and
a storage device configured to store the patient's acknowledgment of the complications.

2. The system of claim 1, wherein the visual representation is three-dimensional.

3. The system of claim 1, wherein the input device is further configured to permit a patient to identify a complication about which the patient desires further information.

4. The system of claim 1, wherein the input device is further configured to permit a user of the system to input outcome information for each patient, the outcome information comprising at least one of the presence or absence of each complication associated with each patient's surgery, the presence or absence of a plurality of pre-operative risk factors associated with each patient's surgery, and the presence or absence of a plurality of outcome factors associated with each patient's surgery, wherein the storage device is further configured to store the outcome information for each patient, and wherein the system further comprises a processor configured to aggregate the outcome information and to determine an outcome based on the aggregated outcome information.

5. The system of claim 4, wherein the outcome determined by the processor is based on at least one of the pre-operative risk factors, the complications, and the outcome factors.

6. The system of claim 4, wherein the input device is further configured to permit a user of the system to input for each patient surgery information comprising at least one of surgeon information, surgery type information, hospital information and geographic information, and wherein the processor is further configured to aggregate the surgery information and to determine an outcome based on the aggregated surgery information.

7. The system of claim 6, wherein the outcome is based on an at least one of the surgeon information, the surgery type information, the hospital information and the geographic information.

8. The system of claim 6, wherein the processor is further configured to determine a surgical volume for at least one of the surgeon information, the surgery type information, the hospital information and the geographic information and determine an outcome based on at least one of the surgeon surgical volume, the surgery type surgical volume, the hospital surgical volume, and the geographic surgical volume.

9. The system of claim 4, wherein the processor is further configured to predict an outcome of a surgery for a patient based on a comparison of the presence or absence of pre-operative risk factors for the patient and the outcome information of other patients stored in the storage device.

10. An automated system for obtaining informed consent from a patient undergoing surgery comprising:
a display configured to display a plurality of complications associated with the surgery;
an input device in communication with the display configured to permit a user of the system to input a patient's acknowledgment of each complication, the input device further being configured to permit a user to input outcome information for each patient, the outcome information comprising at least one of the presence or absence of a plurality of pre-operative risk factors associated with each surgery, the presence or absence of each complication associated with the surgery, and the presence or absence of a plurality of outcomes associated with the surgery;
a storage device configured to store the outcome information for each patient; and
a processor configured to aggregate the outcome information and determine an outcome based on the aggregated outcome information.

11. The system of claim 10, wherein the outcome is based on at least one of the pre-operative risk factors, the complications, and the outcome factors.

12. The system of claim 10, wherein the input device is further configured to permit a user of the system to input surgery information comprising at least one of surgeon information, surgery type information, hospital information and geographic information, and wherein the processor is further configured to aggregate the surgery information and determine an outcome based on the aggregated surgery information.

13. The system of claim 12, wherein the outcome is based on at least one of the surgeon information, the surgery type information, the hospital information and the geographic information.

14. The system of claim 12, wherein the processor is further configured to determine a surgical volume for at least one of the surgeon information, the surgery type information, the hospital information and the geographic information and to determine an outcome based on at least one of the surgeon surgical volume, the surgery type surgical volume, the hospital surgical volume, and the geographic surgical volume.

15. The system of claim 10, wherein the processor is further configured to predict an outcome of a surgery for a patient based on a comparison of the presence or absence of the pre-operative risk factors for the patient and the outcome information of other patients stored in the storage device.

16. An automated method for determining outcomes of surgeries undergone by patients, comprising:
displaying for each surgery a plurality of complications associated with each surgery and at least one of a plurality of pre-operative risk factors and a plurality of outcome factors associated therewith;
storing for each surgery a patient's acknowledgment of each complication and outcome information associated with the surgery, the outcome information comprising at least one of the presence or absence of each complication, the presence or absence of each pre-operative risk factor, and the presence or absence of each outcome factor;
aggregating the outcome information; and
determining an outcome based on the aggregated outcome information.

17. The method of claim 16, wherein the outcome is based on at least one of the pre-operative risk factors, the complications and the outcome factors.

18. The method of claim 16, further comprising:
storing at least one of surgeon information, surgery type information, hospital information and geographic information;
aggregating the surgeon information; and
determining an outcome based on the aggregated surgery information.

19. The method of claim 18, wherein the outcome is based on at least one of the surgeon information, the surgery type information, the hospital information, and the geographic information.

20. The method of claim 18, further comprising:
determining a surgical volume for at least one of the surgeon information, the surgery type information, the hospital information and the geographic information; and
determining an outcome based on the surgeon surgical volume, the surgery type surgical volume, the hospital surgical volume and the geographic surgical volume.

21. The method of claim 16, further comprising:
comparing the pre-operative risk factors for a patient undergoing a surgery to the outcome information for other patients; and
predicting an outcome of the surgery based on the comparison.
